(19) United States
(12) Patent Application Publication
(10) Pub. No.: US 2026/0031591 A1
(43) Pub. Date: Jan. 29, 2026

(54) A CONTINUOUSLY TUNEABLE SIGNAL DEVICE, FOR EXAMPLE A CONTINUOUSLY TUNEABLE LASER DEVICE

(71) Applicant: TECHNISCHE UNIVERSITEIT EINDHOVEN, EINDHOVEN (NL)

(72) Inventors: Martijn Jan Resie HECK, EINDHOVEN (NL); Stefano TONDINI, EINDHOVEN (NL)

(21) Appl. No.: 19/143,970

(22) PCT Filed: Dec. 21, 2023
(86) PCT No.: PCT/NL2023/050676

§ 371 Date: Jun. 27, 2025

(30) Foreign Application Priority Data
Dec. 29, 2022 (NL) 2033863

(51) Int. Cl. H01S 3/10; G02F 1/01; G02F 1/21; G02F 1/225; G02F 1/29; H01P 1/18

(52) U.S. Cl. CPC H01S 3/10053; G02F 1/0121; G02F 1/212; G02F 1/2257; G02F 1/292; H01P 1/18

(57) ABSTRACT

A continuously tuneable signal device, comprising an input stage for receiving an input signal, a plurality of tuneable phase shifters, wherein each of the plurality of tuneable phase shifters is arranged to receive the input signal and wherein each of the plurality of tuneable phase shifters is arranged to phase shift the corresponding received input signal, an output stage for combining the plurality of phase shifted input signals, by the plurality of tuneable phase shifters, for outputting an output signal to a specific wavelength and a driving system for tuning, at an initial condition, some of the plurality of tuneable phase shifters to align the device to the specific wavelength, and for tuning at least one of the remaining of the plurality of tuneable phase shifters to provide for an out-of-phase contribution to the specific wavelength.

### TECHNICAL FIELD

The present disclosure is directed to a signal device and, more specifically, to a tuneable signal device which is continuously tuneable with respect to the wavelength of the signal.

### BACKGROUND

Many photonics applications ask for integrated devices which are widely (>40 nm) and continuously tuneable in wavelength. Continuous tuning means a smooth transition from a starting to an end wavelength over the required optical bandwidth, with a constant/finite wavelength derivative and without major amplitude variations and with, for example, no mode-hopping.

This is however a feature among integrated photonics that is difficult to obtain. As an example, state of art integrated tuneable lasers are either discontinuous, but wide-bandwidth (>40 nm), or continuous, but narrow-band (<10 nm). The same is true for tuneable filters and optical phased arrays.

The reason is because wide tuning is mostly achieved by embedding in the photonic designs multiple-path-interferometers wherein the arms, or paths, have a different length, and wherein these paths can be phase controlled. For multiple arms, multiple times 2π phase tuning is required, but tuning far beyond 2π cannot be reached, as the tuners will then become too large.

Still, after reaching 2π, the tuners can be reset to 0, for the same effect, allowing in principle for continuous tuning.

In reality, due to the limited bandwidth of both electronics and photonics, the reset cannot happen in a smooth manner, i.e. preserving the continuity of the signal. This issue is for example depicted in FIG. 1, where a sawtooth bias scheme is applied to one of the two arms of a Mach-Zehnder Interferometers, MZI. By doing so, it is possible to modulate the transmission of the MZI from a high to a low value for a specific wavelength.

However, at the reset when the bias drops, i.e. the dephasing between the MZI arms passes from 2π to 0, an overshoot of the optical signal is recorded. Unfortunately, this is an intrinsic problem of the electronics and photonics hardware, which can't be prevented by design.

### SUMMARY

It is an object of the present disclosure to provide for a signal device which is able to be continuously tuned over a particular frequency range. It is a further object of the present disclosure to provide for a corresponding method.

In a first aspect of the present disclosure, there is provided A tuneable signal device, comprising
an input stage for receiving an input signal;
a plurality of tuneable phase shifters, wherein each of the plurality of tuneable phase shifters is arranged to receive the input signal and wherein each of the plurality of tuneable phase shifters is arranged to phase shift the corresponding received input signal between a first phase shift and a second phase shift;
an output stage for combining the plurality of phase shifted input signals, by the plurality of tuneable phase shifters, for outputting an output signal to a specific wavelength,
a driving system configured for tuning, at an initial condition, some of the plurality of tuneable phase shifters to align the device to the specific wavelength, and for tuning at least one of the remaining of the plurality of tuneable phase shifters to provide an out-of-phase contribution to the specific wavelength,
and wherein the driving system is further arranged to tune the plurality of tuneable phase shifters to compensate for an error caused by resetting any of the plurality of tuneable phase shifters from the second phase shift to the first phase shift.

The error may be defined as a phase profile degradation, i.e. a phase profile degradation which is caused by resetting any of the plurality of tuneable phase shifters.

The present disclosure is related to a method to tune the phase shifters of a signal device in such a way that the resets from Nπ to 0 (or vice versa) become smooth, therefore leading to a smooth (continuous) operation of the photonic device itself. The strategy prevents the driving electronics to undergo steep transitions (like the one shown in FIG. 1) and therefore extends the tuning capabilities by avoiding discontinuities also when the phase shifters have to be reset. Preferably, N is an even number.

The inventors have found that it is beneficial to use at least one of the phase shifters as compensation to counteract the jittering of the output signal at the reset points of the other phase shifters. This allows to preserve the continuity of the tuning and therefore extends the range of continuous tuneability for photonics devices which share such a scheme.

A reset point may be considered as the point wherein a particular phase shifter changes the phase from a 2π to a 0 phase radian. The phase shifter is then “reset”. In some cases, the phase shifter may also change the phase from a multiple of 2π to a 0 phase radian.

In particular, the tuning starts from an initial condition when all the phase shifters but one are set to align the photonic device to a specific wavelength. The remaining phase shifter is then tuned, i.e. biased, to provide an out-of-phase contribution.

The inventors have found that the “all but one in-phase condition” can be kept along the wavelength tuning with no continuity issues even at the reset points. The out-of-phase phase shifter may gradually be operated to bring an in-phase contribution to compensate for the one(s) which has(ve) to reset, i.e. the one(s) which will contribute to a phase profile degradation (hereinafter error) when bias is switched to pass from Nπ to 0.

Practically, to compensate for the error caused by any phase shifter that is being reset, all (or at least some) other phase shifters are gradually operated to maintain an overall phase summation equivalent to the all but one in-phase condition. In this case, the phase shifter that is being reset may be the out-of-phase phase shifter or may be any of the other phase shifters.

It is further noted that the periodical behaviour of the phase shifters, together with the all but one in-phase initial condition, allows to transfer the out-of-phase condition from one phase shifter to another one.

The general concept may also be viewed as follows. The N phase shifters may be set in a way that peak transmission is (N−2)/N of the total possible transmission at a desired wavelength. This may be achieved by bringing the phase shifters slightly out of phase.

When a particular phase shifter has to be reset by 2π, this may be done while simultaneously the other N−1 phase shifters are moving in phase, in such a way that when the reset is halfway, i.e. at π, all other phase shifters are π out of phase with this particular phase shifter. These N−1 phase shifters are, however, in-phase with one another.

When the particular phase shifter is moving from π to 2π, the other N−1 phase shifters may then be slightly brought out of phase again.

The present disclosure defines that each of the plurality of tuneable phase shifters is arranged to phase shift the corresponding received input signal between a first phase shift and a second phase shift. This means that the tuning is performed at a certain phase, which is a phase difference between the input and the output of the corresponding phase shifter.

The so-called Nπ periodicity is a fundamental concept related to the fact that the optical structures withstand an integer number of wavelengths for a specific wavelength.

This aspect may lead to interference/resonance conditions and it can be exploited for tuning the way the structures, i.e. including the tuneable phase shifters and IO, respond to different wavelengths. It is possible to modify the properties of an optical structure using several effects, for example thermo-optic, electro-optic, etc, thus making it suitable for many other technology/material platforms.

Therefore, most of the approaches to tuneable photonic devices rely on proper engineering of the optical structures, i.e. electro-refractive modulators, waveguides with thermal heaters, etc., which makes them capable of varying the phase of the light/signal upon external, for example electrical/electronic, stimuli.

However, a finite time may be needed for a change of the external inputs to map into a change in the optical properties of the photonic device. This fact may not be detrimental to the continuity of tuning as far as the biasing functions applied to the electronic drivers have a finite first derivative, i.e. the slope the biases changes with is not too steep.

However, driving schemes may also comprise angular points, i.e. edges, that do not have a derivative, i.e. the left and right derivative do not coincide meaning that they are not derivable points. In such conditions, continuity of tuning may still be achieved.

But this condition not always holds, especially for integrated devices, where the amount of electrical power available/allowed on a chip is limited, and the modulo Nπ feature is exploited to overcome this limitation. The effect of biasing the drivers to obtain a phase shift in the optical domain of Nπ+ε is the same as the set of biases to obtain only an ε phase shift.

Thus, when Nπ is reached, the electronic drivers can be switched back to 0 (reset) in order not to invest more power than really needed and, eventually, not to damage the photonic device.

However, during the reset time, the first derivative of one or more driving functions goes theoretically to infinite, by bringing the phase shift immediately from Nπ to 0. In an ideal case, the continuity of tuning should be preserved also at the reset.

In reality, a certain time is needed for a change of the electronics driving to produce the wanted phase shift, i.e. due to bandwidth limitations. This may affect the possibility to achieve continuous tuning. During the time needed for the electronics drivers to accomplish a reset, the phase shift may be affected.

In that specific time frame, one or more driving biases move suddenly to a lower value and, in turn, the output signal undergoes a jitter.

The above stated issue that occurs during a so-called reset of a tuneable phase shifter is remedied in that at least one of the phase shifters provides for an out-of-phase contribution to the specific wavelength before the reset, and may be brought back in phase with the others when a reset takes place.

In an example, the driving system is arranged for tuning the some of the plurality of tuneable phase shifters with a phase between 0 and 2π, being the first phase shift and the second phase shift respectively for the some of the plurality of tuneable phase shifters and for tuning the at least one of the remaining of the plurality of tuneable phase shifters with a phase between 0+x and 2π+x, being the first phase shift and the second phase shift, respectively, for the remaining of the plurality of tuneable phase shifters, wherein x>0.

The at least one of the remaining of the plurality of tuneable phase shifters thus does not provide a phase shift between 0 and 2π, but between different values. This makes these phase shifter(s) out-of-bound.

In a further example, the driving system is arranged for tuning the at least one of the remaining of the plurality of tuneable phase shifters with a phase between π and 3π.

These values constitute a typical working example.

In another example, the signal device is any of a continuously tuneable laser device or a continuously tuneable Radio Frequency, RF, device.

The inventors have found that the above provided insight is beneficial when tuning lasers in a continuous manner, but may also be applicable to Radio Frequency, RF, device, for example in beam steering applications or the like.

The present invention may be deployed in a variety of application including, but not limited to, the following:
optical phased arrays
optical filtering applications
beam steering applications, e.g. wavefront engineering, holography
interferometry applications, e.g. optical coherence tomography
spectroscopy applications, e.g. swept-source Raman spectroscopy, fibre-based transmission spectroscopy
optical switching applications, e.g. reconfigurable optical add drop multiplexing
tuneable evanescent coupling, e.g. whispering gallery mode resonators)
tuneable meta-surfaces including infrared and THz spectrum, e.g. imaging, meta-lenses and focusing devices, information transport
dynamic displays, adaptive coloration
THz plasmonic modulation

In a further example, the driving system is arranged to provide electrical, or thermal, stimuli for tuning the tuneable phase shifters.

In yet another example, at the initial condition, the some of the plurality of tuneable phase shifters are tuned to provide zero degree phase shift to the received input signal. At the initial condition, the at least one of the remaining of the plurality of tuneable phase shifters are tuned to provide a non-zero degree phase shift to the received input signal.

The above provided example highlights the aspect of the present disclosure that at least one of the phase shifters is misaligned compared to the other phase shifters.

In yet another example, the plurality of tuneable phase shifters comprise multi-path-interferometers comprising paths having different lengths, wherein the paths can be phase controlled.

In a second aspect of the present disclosure, there is provided a method of operating a tuneable signal device in accordance with any of the previous claims, wherein the method comprises the steps of:
receiving, by each of the plurality of tuneable phase shifters, the input signal and phase shifting the corresponding received input signal;
tuning, by the driving system, at an initial condition, some of the plurality of tuneable phase shifters to align the device to the specific wavelength, and for tuning at least one of the remaining of the plurality of tuneable phase shifters to provide for an out-of-phase contribution to the specific wavelength, and
tuning, by the driving system, the plurality of tuneable phase shifters to compensate for an error caused by resetting any of the plurality of tuneable phase shifters from the second phase shift to the first phase shift;
combining, by the output stage, the plurality of phase shifted input signals, by the plurality of tuneable phase shifters, for outputting an output signal to a specific wavelength.

The error may be defined as a phase profile degradation, i.e. a phase profile degradation which is caused by resetting any of the plurality of tuneable phase shifters.

It is noted that the advantages as explained with reference to the first aspect of the present disclosure, being the continuously tuneable signal device, are also applicable to the second aspect of the present disclosure, being the method of operating such a signal device.

In an example, the step of tuning comprises:
tuning the some of the plurality of tuneable phase shifters with a phase between 0 and 2π, being the first phase shift and the second phase shift for the some of the plurality of tuneable phase shifters, respectively, and for tuning the at least one of the remaining of the plurality of tuneable phase shifters with a phase between 0+x and 2π+x, being the first phase shift and the second phase shift for the remaining of the plurality of tuneable phase shifters, respectively, wherein x>0.

The phase may be determined using modulo 2π, such that any value higher than 2π is translated to a value in between 0 and 2π. This, i.e. modulo 2π, is applicable to all examples provided in the present disclosure.

In a further example, the step of tuning comprises:
tuning the at least one of the remaining of the plurality of tuneable phase shifters with a phase between π and 3π.

In another example, the signal device is any of a continuously tuneable laser device or a continuously tuneable Radio Frequency, RF, device.

In yet another example, the step of tuning comprises:
providing electrical, or thermal, stimuli for tuning the tuneable phase shifters.

In a further example, the step of tuning comprises:
tuning, at the initial condition, the some of the plurality of tuneable to provide zero degree phase shift to the received input signal.

In yet another example, the step of tuning further comprises:
tuning, at the initial condition, the at least one of the remaining of the plurality of tuneable phase shifters to provide a non-zero radian phase shift to the received input signal.

In an example, the plurality of tuneable phase shifters comprise multi-path-interferometers comprising paths having different lengths, wherein the paths can be phase controlled.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 discloses a waveform of the transmission and the applied sawtooth of a tuneable phase shifter in accordance with the prior art;

FIG. 2 discloses a schematic of a Mach-Zehnder Interferometer;

FIG. 3 discloses a phase shifters' driving scheme;

FIG. 4 discloses a phase shifters' driving scheme in accordance with the present disclosure;

FIG. 5 discloses a phase shifters' driving scheme at a reset moment;

FIG. 6 discloses an example of a phase representation at reset of a particular arm;

FIG. 7 discloses another example of a phase representation at reset of another arm

FIG. 8 discloses a detailed example of the phase shifts of the phase shifters during a reset of one of the phase shifters.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

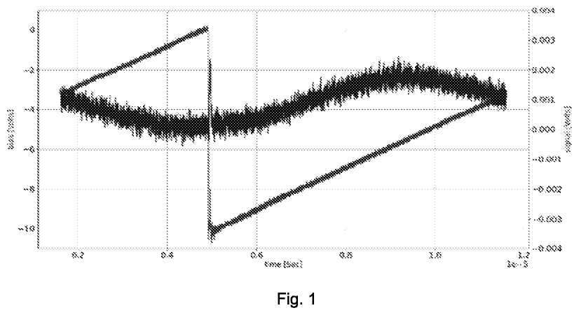

FIG. 1 discloses 1 a waveform of the transmission 2 and the applied sawtooth 3 of a tuneable phase shifter in accordance with the prior art.

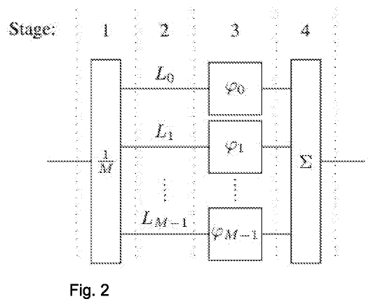

FIG. 2 discloses a schematic 11 of a Mach-Zehnder Interferometer, MZI.

To ease the understanding of the present disclosure, a specific implementation case is described, namely the tuning of a cascaded MZI-based photonic filter. However, the underlying principles can be applied to any signal device, for example laser device or RF device, where the tuning stage is based on multiple phase shifters which are, for example, controlled by functions modulo Nπ.

A normalized sinc-like shaped filter can be built from the combination of a finite set of cosine functions:

$${sinc}_{t r} ( x ) = \frac{1}{n} {\sum }_{i = 0}^{n - 1} cos ( \frac{i x}{n - 1} ) \qquad Eq . 1$$

In the photonic domain, a sinc-shaped filter can be achieved using an MZI, which splits 12 up a waveguide into separated arms 13 and then combines 14 them again after a certain distance. Adding a path difference ΔL between the arms implies a sinusoidal wavelength dependency in the output transmission:

$${T}_{{MZI}_{2 \_ arms}} = \frac{1}{2} + \frac{1}{2} cos ( \frac{k}{λ} Δ L + ϑ ) \qquad Eq . 2$$

where k=2π/n_{eff} (being n_{eff} the effective index of the waveguide), λ is the wavelength of the light in vacuum, and θ is an arbitrary phase term. By using n MZI arms with a linearly increasing arm length according to L=iΔL, where where (i=0, 1, . . . , n−1), a wavelength-dependent sinc-like filter can be obtained, as shown by Eq. 1.

Eq. 3 specifies Eq. 2 in the case of an 8-arm MZI

$${T}_{{MZI}_{8 \_ arms}} = \frac{1}{8} {\sum }_{i = 0}^{7} cos ( i \frac{{k}^{′}}{λ * 7} Δ L + {ϑ}_{i} ) \qquad Eq . 3$$

where k′=k*7.

A corresponding filter schematic is shown in FIG. 2.

If proper arbitrary phase terms θi are applied to each arm, the pass-band of the filter will shift in wavelength.

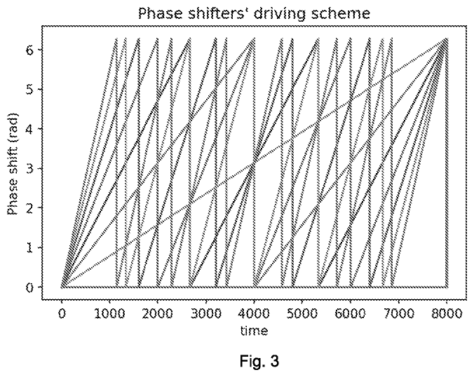

FIG. 3 discloses a phase shifters' driving scheme 31, wherein a combination of different sawtooth functions is making the filter pass-band shift in time and in frequency.

Each sawtooth function visualized the phase shift of one particular tuneable phase shifter of the signal device. As shown, over the full horizontal span, some phase shifters will “cycle” multiple times from zero to 2π. One phase shifter may be arranged to provide a single linear increase from zero to 2π. All the others at least cycle from zero to 2π multiple times. As such, multiple reset moments occur in the tuneable phase shifters, i.e. the moments when the phase shifters resets from 2π phase shift to a zero phase shift. This is indicated with the very steep vertical lines in FIG. 3.

The problem as described above is common to many different signal device, for example photonic devices like integrated laser, optical phased arrays and non-optical phased arrays. Even though not always a driving scheme like the one shown in FIG. 3 is needed, still a harsh phase reset in signal devices is an important point to consider.

This problem, for instance, is preventing a smooth tuning of the filter being described here. Moreover, solving this problem enables extending the tuneability for integrated lasers over a wider range, for example to more than 50 nm. This, in turn, will open to a full range of application-driven opportunities, e.g. biomedical and THz imaging, fibre-optic sensing, and (gas) spectroscopy, which still lack of broadband and continuously tuneable laser sources.

One of the aspects of the present disclosure allows for overcoming the problem detailed so far. In particular, it leverages the implementation of a smooth reset of phase at each edge shown in FIG. 3, i.e. a reset strategy wherein the phase profile remains a continuous function for each phase shifter.

To do so, the idea is to misalign at least one of the arms beforehand and exploit then the margin obtained this way to relax the driving functions at the reset point, thereby keeping the peak filter transmission constant over time/tuning.

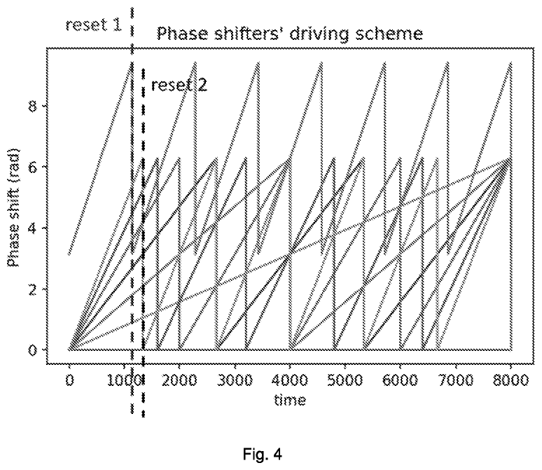

The implementation 31 of such a strategy is visualized, in an example, in FIG. 4, and starts from a new driving scheme for driving the tuneable phase shifters. The phase shift function to be applied to, for example, the last arm of the filter is moved upward by π, as indicated with reference numeral 42. FIG. 4 thus shows an example of a new starting condition wherein at least one arm starts with a phase shift of π, while the others start with a zero phase shift.

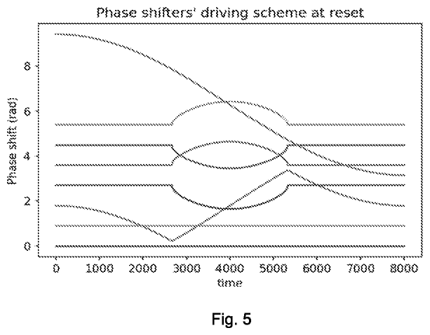

The graphical representation 51 of the first phase shift reset highlighted from FIG. 4 is shown in FIG. 5. The reset transition, at the first reset, can be smothered as shown in FIG. 5.

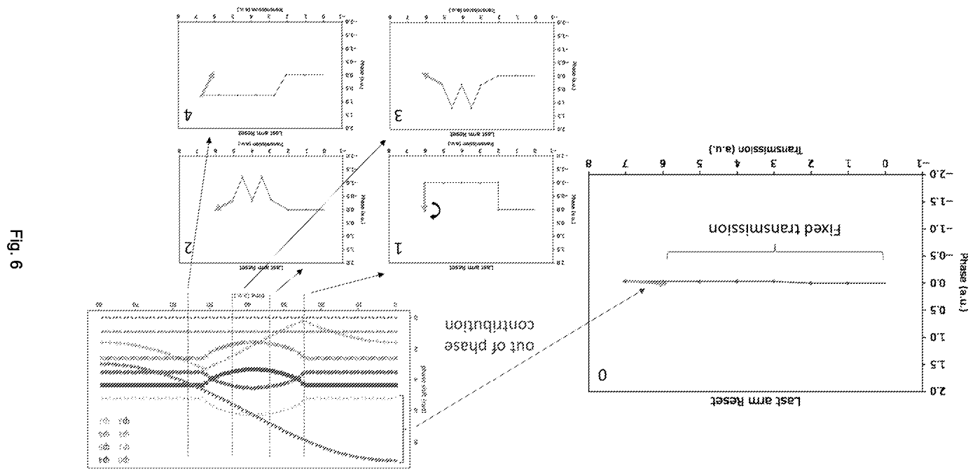

FIG. 6 discloses an example showing the reset of the last arm of an 8-arm filter. The figures depict a series of arrows (phasors) that build the overall transmission of the filter at a specific wavelength (the projection of the arrows onto the x-axis), at different moment in times during the reset as indicated with the specific arrows.

The phase shift component brought by every single arm is represented by the angle that the arrows make with the x-axis. It is shown that the overall filter transmission remains the same while the arrow representing the last arm (the rightmost one) undergoes a phase shift of 2Pi.

The other arms perform accordingly to keep the overall transmission constant. In such a way, the reset transition can be smothered as shown on the top right figure. When the arms' phases are driven by the functions shown in the figures, the reset of one arm not affected by the issue of the bandwidth limitation of the phase shifters can be achieved.

It is noted that the method in accordance with the present disclosure may be applicable for any arbitrary starting condition.

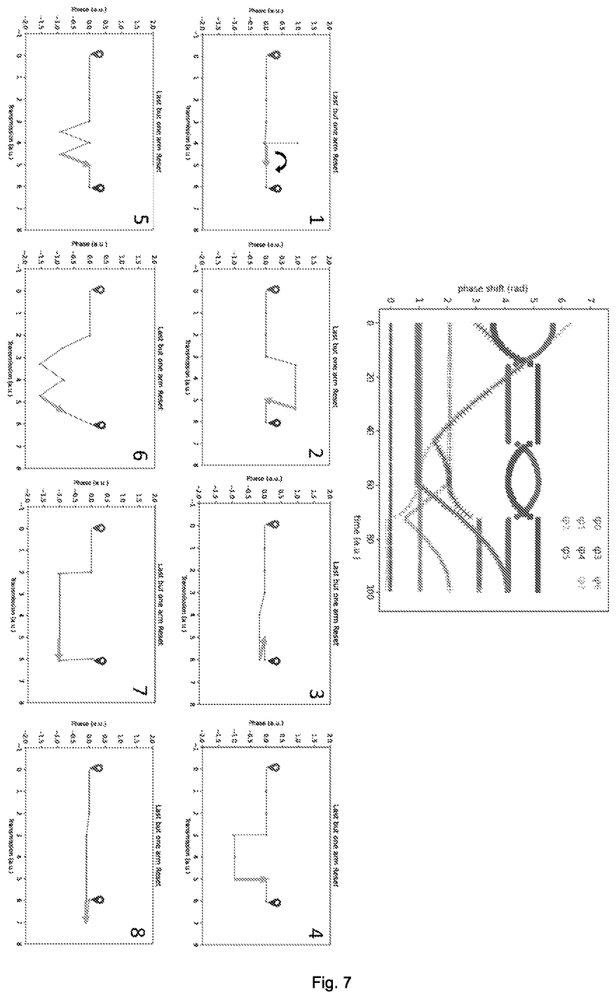

FIG. 7, for example, shows the phase representation, at multiple instances of time, during reset of the last but-one arm. This thus starts from a different initial condition.

The overall transmission is, in this case as well, still fixed at N−2 and is represented by the fact that the last pins, i.e. the ones at X=0 and X=6, are fixed.

It is noted that, in the figures provided above, the number of arms is N and having N−2 transmission. However, the present disclosure is not limited to an N−2 transmission. In case of a plurality of arms, it may become possible to reset two arms at the same time, thereby resulting in an N−4 transmission, for example.

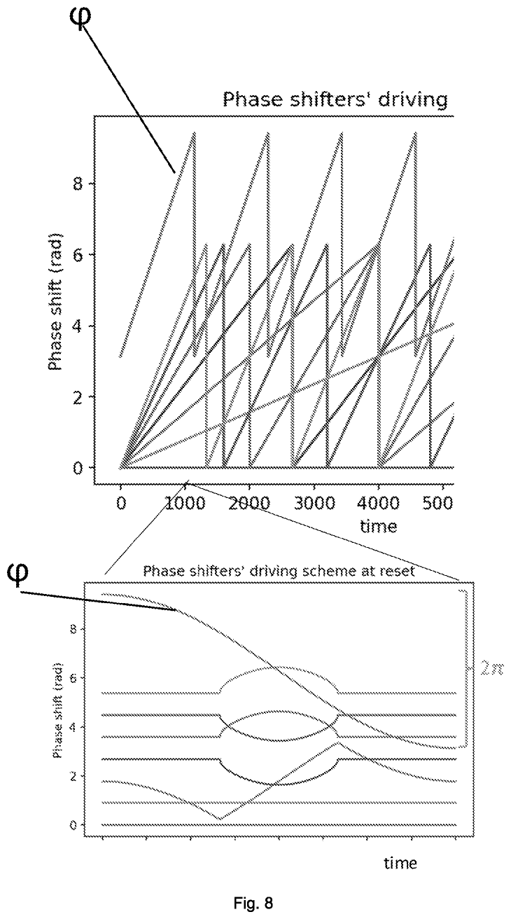

It is further noted that the driving system may tune, at the initial condition, the tuneable phase shifters to align the device to the specific wavelength to achieve a normalized transmission less than or equal to (N−2)/N, wherein N is the total number of arms, i.e. phase shifters, in the system. FIG. 8 discloses a detailed example of the phase shifts of the phase shifters during a reset of one of the phase shifters.

More specifically, reference is made to the phase shift of the phase shifter as indicated with the reference numeral φ7. It is shown that the phase shift is increased to 3*pi and then is reset to 1*pi. The figure at the bottom side of FIG. 6 is a zoomed version of this particular reset.

In this zoomed version, it is shown that the same phase shift is reset from 3*pi to 1*pi. The time axis at the horizontal axis is however much slower compared to that one of the upper figure of FIG. 6. The two time axis could also be the same scale.

The remaining arms, i.e. phase shifters, compensate for the error caused by the reset of this particular phase shifter. This is shown by the remaining phase shifts of the phase shifters.

The error may be defined as a phase profile degradation, i.e. a phase profile degradation which is caused by resetting any of the plurality of tuneable phase shifters.

The present disclosure is related to a new method for the phase shifters of signal devices, for example photonic device. In fact, the discontinuity issues described in the previous sections, i.e. caused by resetting the phase shifters from 2π to 0, i.e. resetting by +/−2π, are caused by intrinsic limitations of the hardware which can be solved by a non-trivial operation of the tuning stage.

The reset driving scheme will also work on various implementations and technologies, where the tuning stage is made by multiple degrees of freedom ruled by functions modulo Nπ.

The reset method opens to an unprecedented capability of extending the range of continuous tuning for integrated devices. The method here described is suitable for a broad spectrum of applications, where the finite bandwidth of the building blocks (photonics and electronics) is the main limit to the overall performance.

The novel benefits resulting from the invention are also diverse, among others:
Increased sweep speed and sweep stabilization
Better temperature management/distribution, especially at the reset points
Enhanced scanning resolution for the applications like spectroscopy, optical metrology or imaging, etc.
Mode-hop free operation if the invention is applied to integrated tuneable lasers.

To reduce the number of claims, certain aspects of the technology are presented below in certain claim forms, but the applicant contemplates the various aspects of the technology in any number of claim forms. For example, while some aspect of the technology may be recited as a computer-readable medium claim, other aspects may likewise be embodied as a computer-readable medium claim, or in other forms, such as being embodied in a means-plus-function claim.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1. A tuneable signal device, comprising
an input stage for receiving an input signal;
a plurality of tuneable phase shifters, wherein each of the plurality of tuneable phase shifters is arranged to receive the input signal and wherein each of the plurality of tuneable phase shifters is arranged to phase shift the corresponding received input signal between a first phase shift and a second phase shift;
an output stage for combining the plurality of phase shifted input signals, by the plurality of tuneable phase shifters, for outputting an output signal to a specific wavelength,
a driving system configured for tuning, at an initial condition, some of the plurality of tuneable phase shifters to align the device to the specific wavelength, and for tuning at least one of the remaining of the plurality of tuneable phase shifters to provide an out-of-phase contribution to the specific wavelength,
and wherein the driving system is further arranged to tune the plurality of tuneable phase shifters to compensate for an error caused by resetting any of the plurality of tuneable phase shifters from the second phase shift to the first phase shift.

2. A tuneable signal device in accordance with claim 1, wherein the driving system is arranged for tuning the some of the plurality of tuneable phase shifters with a phase between 0 and 2π, being the first phase shift and the second phase shift respectively for the some of the plurality of tuneable phase shifters, and for tuning the at least one of the remaining of the plurality of tuneable phase shifters with a phase between 0+x and 2π+x, being the first phase shift and the second phase shift respectively for the remaining of the plurality of tuneable phase shifters, wherein x>0.

3. A tuneable signal device in accordance with claim 2, wherein the driving system is arranged for tuning the at least one of the remaining of the plurality of tuneable phase shifters with a phase between π and 3π, being the first phase shift and the second phase shift respectively for the remaining of the plurality of tuneable phase shifters.

4. A tuneable signal device in accordance with any of the previous claims, wherein the signal device is any of a continuously tuneable laser device, a continuously tuneable Radio Frequency, RF, device, an optical phased array or RF/microwave phased array.

5. A tuneable signal device in accordance with any of the previous claims, wherein the driving system is arranged to provide electrical, or thermal, stimuli for tuning the tuneable phase shifters.

6. A tuneable signal device in accordance with any of the previous claims, wherein, at the initial condition, the some of the plurality of tuneable phase shifters are tuned to provide zero radian phase shift to the received input signal.

7. A tuneable signal device in accordance with claim 6, wherein, at the initial condition, the at least one of the remaining of the plurality of tuneable phase shifters are tuned to provide a non-zero radian phase shift to the received input signal.

8. A tuneable signal device in accordance with any of the previous claims, wherein the plurality of tuneable phase shifters comprise multi-path-interferometers comprising paths having different lengths, wherein the paths can be phase controlled.

9. A tuneable signal device in accordance with any of the previous claims, wherein the device is implemented on an indium phosphide based or silicon photonics based photonic integration platform.

10. A method of operating a tuneable signal device in accordance with any of the previous claims, wherein the method comprises the steps of:
receiving, by each of the plurality of tuneable phase shifters, the input signal and phase shifting the corresponding received input signal;
tuning, by the driving system, at an initial condition, some of the plurality of tuneable phase shifters to align the device to the specific wavelength, and for tuning at least one of the remaining of the plurality of tuneable phase shifters to provide for an out-of-phase contribution to the specific wavelength, and
tuning, by the driving system, the tuneable phase shifters to compensate for an error caused by resetting any of the tuneable phase shifters from the second phase shift to the first phase shift;
combining, by the output stage, the plurality of phase shifted input signals, by the plurality of tuneable phase shifters, for outputting an output signal to a specific wavelength.

11. A method in accordance with claim 10, wherein the step of tuning comprises:
tuning the some of the plurality of tuneable phase shifters with a phase between 0 and 2π, being the first phase shift and the second phase shift for the some of the plurality of tuneable phase shifters, respectively, and for tuning the at least one of the remaining of the plurality of tuneable phase shifters with a phase between 0+x and 2π+x, being the first phase shift and the second phase shift for the remaining of the plurality of tuneable phase shifters, respectively, wherein x>0.

12. A method in accordance with claim 11, wherein the step of tuning comprises:
tuning the at least one of the remaining of the plurality of tuneable phase shifters with a phase between π and 3π, being the first phase shift and the second phase shift for the remaining of the plurality of tuneable phase shifters, respectively.

13. A method in accordance with any of the claims 10-12, wherein the signal device is any of a continuously tuneable laser device or a continuously tuneable Radio Frequency, RF, device.

14. A method in accordance with any of the claims 10-13, wherein the step of tuning comprises:
providing electrical, or thermal, stimuli for tuning the tuneable phase shifters.

15. A method in accordance with any of the claims 10-14, wherein the step of tuning comprises:
tuning, at the initial condition, the some of the plurality of tuneable to provide zero radian phase shift to the received input signal.

16. A method in accordance with claim 15, wherein the step of tuning further comprises:
tuning, at the initial condition, the at least one of the remaining of the plurality of tuneable phase shifters to provide a non-zero radian phase shift to the received input signal.

17. A method in accordance with any of the claims 10-16, wherein the plurality of tuneable phase shifters comprise multi-path-interferometers comprising paths having different lengths, wherein the paths can be phase controlled.
